(19) United States
(12) Patent Application Publication
(10) Pub. No.: US 2014/0194081 A1
(43) Pub. Date: Jul. 10, 2014

(54) Superheterodyne Receiver

(71) Applicant: Huawei Technologies Co., Ltd., Shenzhen (CN)

(72) Inventors: Massoud Tohidian, Delft (NL); Iman Madadi, Delft (NL); Robert Bogdan Staszewski, Delft (NL)

(73) Assignee: Huawei Technologies Co., Ltd., Shenzhen (CN)

(21) Appl. No.: 14/145,463

(22) Filed: Dec. 31, 2013

Related U.S. Application Data
(63) Continuation-in-part of application No. PCT/EP2012/062029, filed on Jun. 21, 2012.

(51) Int. Cl. H04B 1/26

(52) U.S. Cl. CPC H04B 1/26
USPC 455/258

(57) ABSTRACT

The invention relates to a superheterodyne receiver, comprising: a sampling mixer being configured to sample an analog radio frequency signal using a certain sampling rate (fₛ) to obtain a discrete-time sampled signal, and to shift the discrete-time sampled signal towards a first intermediate frequency (|f_{RF}−f_{LO}|) to obtain an intermediate discrete-time signal sampled at the fₛ; a discrete-time filter being configured to filter the intermediate discrete-time signal at the fₛ to obtain a filtered signal; and a discrete-time mixer being configured to shift the filtered signal towards a second intermediate frequency (f_{IF}).

### CROSS-REFERENCE TO RELATED APPLICATIONS

This application is a continuation-in-part of International Application No. PCT/EP2012/062029, filed on Jun. 21, 2012, which is hereby incorporated by reference in its entirety.

### BACKGROUND

The present invention relates to a superheterodyne receiver and a superheterodyne receiving method, in particular a superheterodyne receiving method for receiving an analog radio frequency (RF) signal.

Receivers are electronic circuits that receive RF signal at high frequency and down-convert it to baseband for further processing and demodulation. They usually amplify the weak desired RF signal and filter undesired adjacent signals and blockers around. A receiver is commonly tunable by changing the local oscillator (LO) frequency of its local oscillator to receive a specific channel in a certain band.

Multi-band receivers are able to receive a signal from two or more different bands located at different frequencies. Since these bands might be located far from each other, a multi-band receiver should be tunable or programmable to cover all desired bands.

A multi-standard receiver can receive signals of different standards. One of the main differences between these standards is signal bandwidth. Therefore, bandwidth of a multi-standard receiver must be selectable to cover different standards. However, other requirements of receiver such as a receiver frequency, sensitivity, linearity, filtering requirement, etc., might be different in different standards. Rather than including multiple different receivers for different bands or standards, a single multi-band/multi-standard receiver might be used with programmable receiver frequency and input bandwidth.

The conventional superheterodyne receiver architecture 1100 as illustrated in FIG. 11 provides high quality filtering at intermediate frequency (IF), flicker free gain at IF but applies fixed intermediate frequency. A received radio frequency signal with frequency f_{RF}=f_{LO}+f_{IF} in the superheterodyne receiver architecture 1100 passes a pre-select stage 1101, a low noise amplifier (LNA) 1103, an RF mixer 1105, an intermediate frequency (IF) filter 1107, an IF amplifier 1109, an IF mixer 1111, a channel selector 1113, a baseband gain stage 1115 and analog-to-digital converter (ADC) 1117 before it is passed to the digital baseband processor modem 1119 for further processing.

However, due to quadrature operation of mixer 1205 multiplying the desired band of frequency ω₁ with the local oscillator (LO) frequency ω_{LO} as depicted in the frequency diagram 1200 of FIG. 12, images 1203 of the desired band 1201 are aliased at intermediate frequency (IF) resulting in undesired aliasing components 1209 in IF band of frequency ω_{IF}. After the RF mixer 1105 a low pass filter (LPF) 1207 is used for low pass filtering the output signal of the RF mixer 1105.

Receivers should support multi-band multi-standard operation to cover a wide range of communication standards. On the other hand, to be cost effective it is desired to highly integrate it as a single chip preferably in a nano-scale complementary metal-oxide-semiconductor (CMOS) process. Homodyne architecture (including zero intermediate frequency (ZIF) and low intermediate frequency (LIF)) is a common receiver structure due to its well-recognized capability of monolithic integration. FIG. 13 illustrates a common homodyne receiver architecture 1300. A received radio frequency signal with frequency f_{RF}=f_{LO} in the homodyne receiver architecture 1300 passes a pre-select stage 1301, a low noise amplifier 1303, a mixer 1305, a channel selector 1307, a baseband gain stage 1309 and an analog-to-digital converter 1311 before it is passed to the digital baseband processor modem 1313 for further processing.

However, the homodyne receiver architecture 1300 suffers from several technical problems, which require special attention to make this architecture suitable for different communication standards. Different interference phenomena 1400 are illustrated in FIG. 14 depicting a homodyne receiver with a low noise amplifier 1401, a mixer 1403, a low pass filter 1405, a gain stage 1407 and an analog-to-digital converter 1409.

Direct current (DC) offset is a common problem in the ZIF structure caused by self-mixing of the local oscillator (LO) signal cos ω_{LO}t amplified or not amplified through the LNA 1401 or strong interferer at the down-converting mixer 1403 as illustrated in FIG. 14. It would be worse if LO leakage reaches to the antenna. In this case, it will cause time-varying DC offset dependent on the ever-varying antenna environment. Therefore, normally DC offset cancellation techniques need to be used for ZIF. Since LO frequency is substantially the same as input RF frequency, the LO leakage can be higher than in case of a receiver with different LO frequency. In some cases, LO leakage calibration is needed. Also, second-order intermodulation (IM2) is a common problem in ZIF, which usually needs a second order intercept point (IP2) calibration. In the ZIF structure, normally a small part of receiver gain is provided at RF stage and the major part is provided at baseband (BB) stages. Therefore, flicker noise of baseband (BB) amplifier increases the total noise floor (NF) of the system. Designers usually try to minimize it by using large transistor sizes in BB. Moreover, since the first filtering is performed in BB and considering the RF gain before BB, the first BB filter has to be highly linear. Operational amplifier (opamp)-based or transconductance (gₘ)-capacitance (C) based biquad filter is a well-known block for this purpose but it consumes high power.

Superheterodyne architecture, as depicted in FIG. 15, has been recognized to solve the above problems. A received radio frequency signal with frequency f_{RF}=f_{LO}+f_{IF} in the superheterodyne receiver architecture 1500 passes a pre-select stage 1505, a low noise amplifier 1507, an RF mixer 1509, an external (off-chip) intermediate frequency (IF) filter 1503, an IF amplifier 1511, an IF mixer 1513, a channel selector 1515, a baseband gain stage 1517 and an analog-to-digital converter 1519 before it is passed to the digital modem 1521 for further processing.

However, the conventional superheterodyne receiver architecture 1500 as depicted in FIG. 15 introduces its own set of problems. IF filter 1503, are conventionally implemented as off-chip components, which are costly. Then high power for I/O buffers is needed to drive the off-chip IF filter 1503. Further, the off-chip IF filter 1503 is only accessible through bond wires, which provide parasitic inductance and capacitance. In addition, the receiver with a fixed frequency IF filter requires two independent local oscillators, one to down-convert from RF to IF and another one to down-convert from IF to BB.

### SUMMARY

It is the object of the invention to provide a concept for a superheterodyne receiver providing improved noise rejection, flexible bandwidth filtering and efficient implementation.

This object is achieved by the features of the independent claims. Further operational forms are apparent from the dependent claims, the description and the figures.

The invention is based on the finding that a discrete-time receiver front-end with high sampling rate at RF input with deferred decimation improves the noise floor of the received signal. The received signal is oversampled at RF stage and this high sampling rate is used for RF discrete-time (DT) mixing and maintained at least after a first (full-rate) DT filter. This allows efficient filtering of image frequencies and blocker signals. By applying DT quadrature IF mixer structures, negative frequency image rejection is provided. Thanks to the filtering at IF stage, linearity at baseband is more relaxed and instead of highly linear biquad operational amplifier (opamp) based filter, efficient DT filters based on simple inverter based gₘ stage with low power consumption can be used. After the DT IF mixer, the DT signal can be down-converted to baseband (BB). The BB signal path through several filters and decimations can be prepared for analog-digital-conversion. This is feasible and preferable in nano-scale CMOS with transistors acting as very fast switches and with high-density capacitors such as metal-oxide-metal (MoM), and metal-oxide-semiconductor (MOS).

The invention is further based on the finding that a superheterodyne receiver applying high sampling rate at input with deferred decimation provides excellent image rejection and is easy to implement. By employing image reject topology for the mixers, a full rate Infinite impulse response (IIR) filter at IF stage can be used for filtering out alias frequencies of the IF mixer. By using variable high-IF frequency, e.g. sliding IF, one LO is sufficient for the whole receiver providing flexible bandwidth filtering. A powerful discrete-time baseband filtering before delivering the received signal to ADC further improves image rejection.

In order to describe the invention in detail, the following terms, abbreviations and notations will be used:
RF: radio frequency,
IF: intermediate frequency,
ZIF: zero intermediate frequency,
LIF: low intermediate frequency,
LO: local oscillator,
BB: baseband,
BW: bandwidth,
LPF: low-pass filter,
BPF: band-pass filter.

According to a first aspect, the invention relates to a superheterodyne receiver, comprising: a sampling mixer being configured to sample an analog radio frequency signal using a certain sampling rate to obtain a discrete-time sampled signal, and to shift the discrete-time sampled signal towards a first intermediate frequency to obtain an intermediate discrete-time signal sampled at the certain sampling rate; a discrete-time filter being configured to filter the intermediate discrete-time signal at the certain sampling rate to obtain a filtered signal; and a discrete-time mixer being configured to shift the filtered signal towards a second intermediate frequency.

In a first possible implementation form of the superheterodyne receiver according to the first aspect, the second intermediate frequency is a baseband frequency.

In a second possible implementation form of the superheterodyne receiver according to the first aspect as such or according to the first implementation form of the first aspect, the discrete-time mixer is configured to operate at a decimated sampling rate, which is lower than the certain sampling rate.

In a third possible implementation form of the superheterodyne receiver according to the first aspect as such or according to any of the preceding implementation forms of the first aspect, the discrete-time mixer is an image-reject mixer.

In a fourth possible implementation form of the superheterodyne receiver according to the first aspect as such or according to any of the preceding implementation forms of the first aspect, the discrete-time filter is a low-pass filter or a band-pass filter, in particular a complex band-pass filter.

In a fifth possible implementation form of the superheterodyne receiver according to the first aspect as such or according to any of the preceding operational forms of the first aspect, the discrete-time filter is configured to perform a charge sharing between an in-phase and a quadrature component of the intermediate discrete-time signal.

In a sixth possible implementation form of the superheterodyne receiver according to the first aspect as such or according to any of the preceding implementation forms of the first aspect, the certain sampling rate is an oversampling rate with an oversampling factor which is at least 2 or at least 4.

In a seventh possible implementation form of the superheterodyne receiver according to the first aspect as such or according to any of the preceding implementation forms of the first aspect, the discrete-time filter comprises a switched capacitor network, and the switched capacitor network comprises an input and an output, a number of parallel switched capacitor paths arranged between the input and the output, each switched capacitor path comprising a switched capacitor, and a switch circuitry for switching each switched capacitor of the number of parallel switched capacitors at a different time instant for outputting a filtered input signal.

In an eighth possible implementation form of the superheterodyne receiver according to the seventh implementation form of the first aspect, the switch circuitry is configured to switch each switched capacitor beginning with a different phase of a common clock signal.

In a ninth possible implementation form of the superheterodyne receiver according to the seventh or the eighth implementation form of the first aspect, the switch circuitry comprises a number of input switches for switching each switched capacitor to the input for charging the switched capacitors, the switch circuitry further comprises a number of output switches for switching each switched capacitor to the output for sequentially outputting a number of filtered sub-signals collectively representing the filtered input signal, and the switch circuitry further comprises a number of discharge switches, each discharge switch being arranged to switch one switched capacitor to a reference potential for discharging.

In a tenth possible implementation form of the superheterodyne receiver according to the first aspect as such or according to any of the preceding implementation forms of the first aspect, the sampling mixer is a quadrature mixer comprising an in-phase path and a quadrature path, the in-phase path is configured to generate an in-phase oscillator signal with the repeating function [1 0 −1 0] and the quadrature-phase path is configured to generate a quadrature phase oscillator signal with the repeating function [0 1 0−1].

In an eleventh possible implementation form of the superheterodyne receiver according to the first aspect as such or according to any of the preceding implementation forms of the first aspect, the sampling mixer is a quadrature mixer comprising an in-phase path and a quadrature path, the in-phase path is configured to generate an in-phase oscillator signal with the repeating function [1 1+√2 1+√2 1 −1 −1−√2 −1−√2 −1] and the quadrature-phase path is configured to generate a quadrature phase oscillator signal with the repeating function [−1−√2 −1 1 1+√2 1+√2 1 −1−1√2].

In a twelfth possible implementation form of the superheterodyne receiver according to the first aspect as such or according to any of the preceding implementation forms of the first aspect, the discrete-time mixer comprises a down-sampler for providing the filtered signal shifted towards the second intermediate frequency with a sampling rate reduced towards the certain sampling rate.

In a thirteenth possible implementation form of the superheterodyne receiver according to the first aspect as such or according to any of the preceding implementation forms of the first aspect, the superheterodyne receiver further comprises a converting amplifier for converting a voltage signal into a current signal, in particular a gₘ stage, connected to the output of the discrete-time filter.

In a fourteenth possible implementation form of the superheterodyne receiver according to the first aspect as such or according to any of the preceding implementation forms of the first aspect, the sampling mixer is a quadrature sampling mixer.

By using such superheterodyne frequency receiver, disadvantages of both ZIF (including LIF) and superheterodyne architectures can be avoided. The superheterodyne receiver according to aspects of the invention is insensitive to 2nd-order nonlinearities; LO leakage to antenna is substantially reduced; time varying DC offset problem is solved and the radio frequency receiver according to aspects of the invention is insensitive to the flicker noise. The flicker noise typically gets worse with CMOS scaling, thereby presenting severe impediments to the integration progress, which are solved when using the superheterodyne receiver according to aspects of the invention.

A superheterodyne receiver according to the first aspect of the invention can be fully integrated without off-chip IF filter, thus it is a low cost receiver. As filtering bandwidth can be precisely selected with capacitor ratio and clock rate, the superheterodyne receiver according to aspects of the invention is less sensitive to process-voltage-temperature (PVT). The receiver's IF frequency is selectable. For example, for a given input RF frequency, IF can be selected between f_{LO}/4, f_{LO}/8, f_{LO}/16 etc. This capability allows changing IF from one to another in busy environments to tolerate more powerful blocker signals. Discrete-time signal processing can be done by switches and capacitors. The more advanced the technology is, the faster the switches are and the higher the capacitor density is. Therefore, it is process scalable with Moore's law.

The superior structure of a superheterodyne receiver according to the first aspect of the invention allows using simple inverter-based gₘ stage instead of complex opamp-based structures for signal processing and filtering. This results in lower power consumption.

According to a second aspect, the invention relates to a superheterodyne receiving method, comprising: sampling an analog radio frequency signal using a certain sampling rate to obtain a discrete-time sampled signal; shifting the discrete-time sampled signal towards a first intermediate frequency to obtain an intermediate discrete-time signal sampled at the certain sampling rate; discrete-time filtering the intermediate discrete-time signal at the certain sampling rate to obtain a filtered signal; and shifting the filtered signal towards a second intermediate frequency.

### BRIEF DESCRIPTION OF THE DRAWINGS

Further embodiments of the invention will be described with respect to the following figures, in which:

FIG. 1 shows a block diagram of a superheterodyne receiver according to an operational form;

FIG. 2 shows a block diagram of a superheterodyne receiver according to an operational form;

FIG. 3 shows a block diagram of a discrete-time filter of a superheterodyne receiver according to an operational form;

FIG. 4 shows a set of switching signals for controlling the switches of a discrete-time filter according to an operational form;

FIG. 5 shows a block diagram of a superheterodyne receiver according to an operational form;

FIG. 6 shows a block diagram of a post filtering stage of a superheterodyne receiver according to an operational form;

FIG. 7 shows a block diagram of an anti-aliasing filter of a superheterodyne receiver according to an operational form;

FIG. 8 shows a block diagram of an analog amplifier of a radio frequency receiver in continuous-time representation according to an operational form;

FIG. 9 shows a block diagram of an analog amplifier of a radio frequency receiver in discrete-time representation according to an operational form;

FIG. 10 shows a schematic diagram of a method for receiving an analog radio frequency signal according to an operational form;

FIG. 11 shows a block diagram of a conventional superheterodyne receiver architecture;

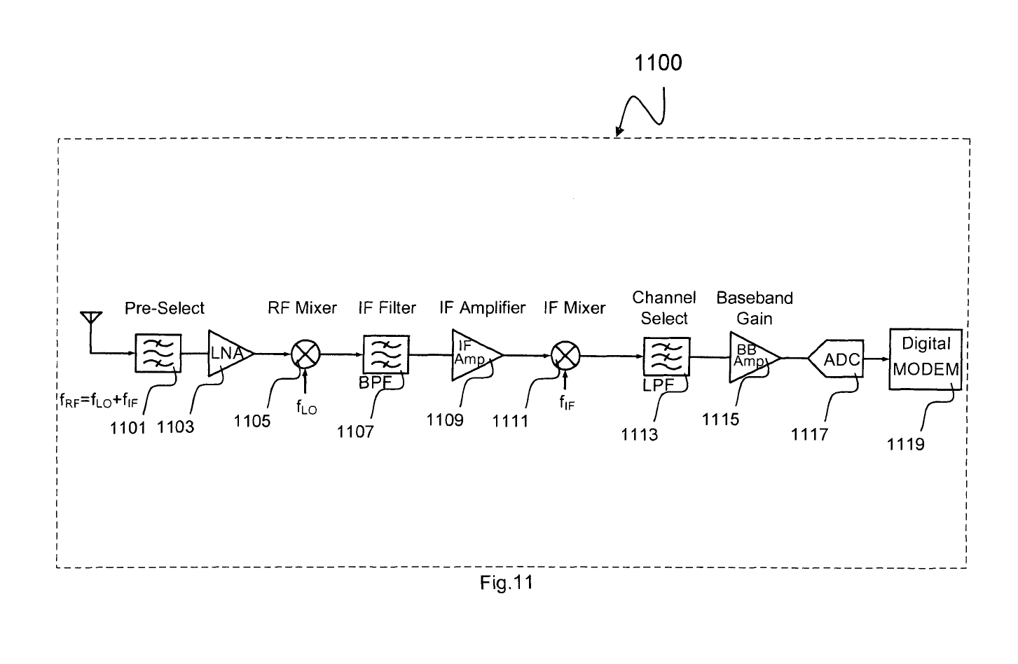

FIG. 12 shows a frequency diagram of a received signal in a conventional superheterodyne receiver architecture;

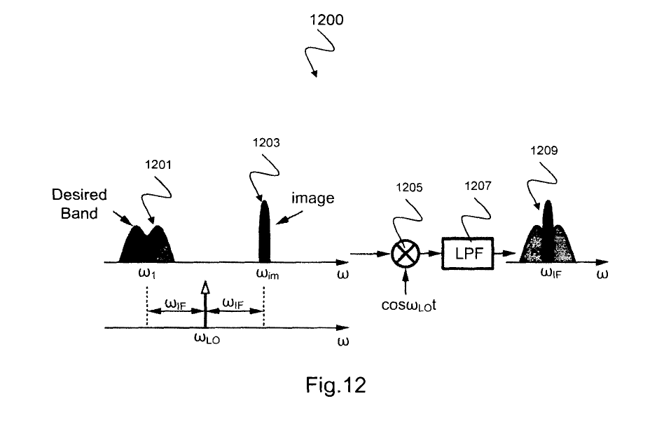

FIG. 13 shows a block diagram of a conventional homodyne receiver architecture;

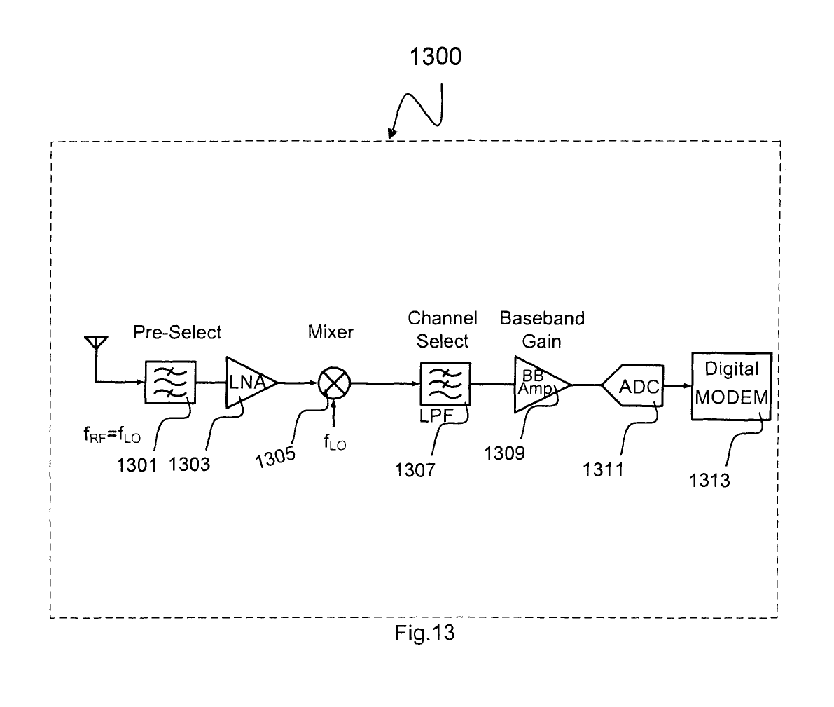

FIG. 14 shows a frequency diagram of a received signal in a conventional homodyne receiver architecture; and

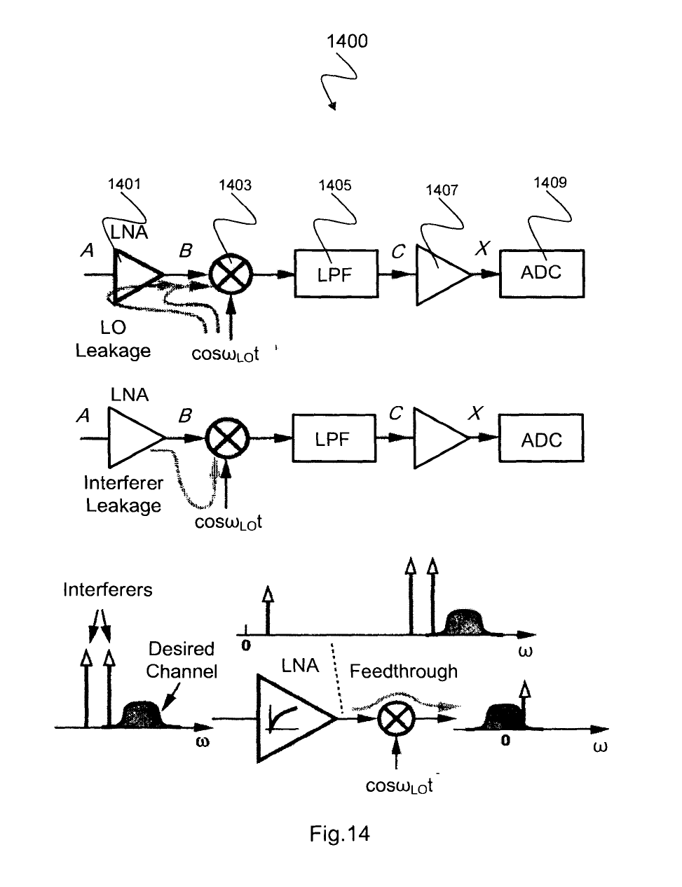

FIG. 15 shows a block diagram of a conventional superheterodyne receiver architecture with off-chip IF filtering.

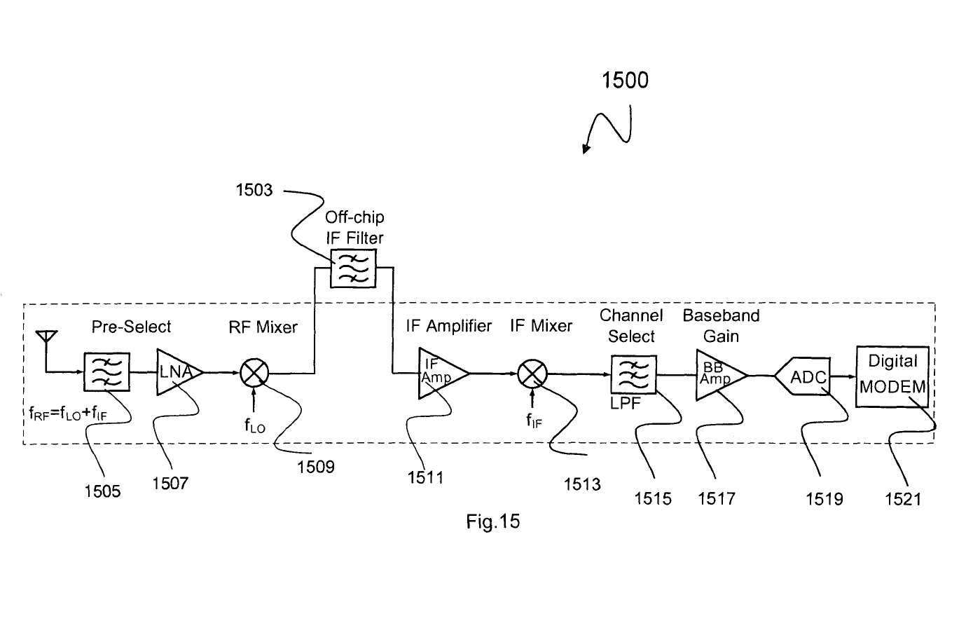

### DETAILED DESCRIPTION OF EMBODIMENTS

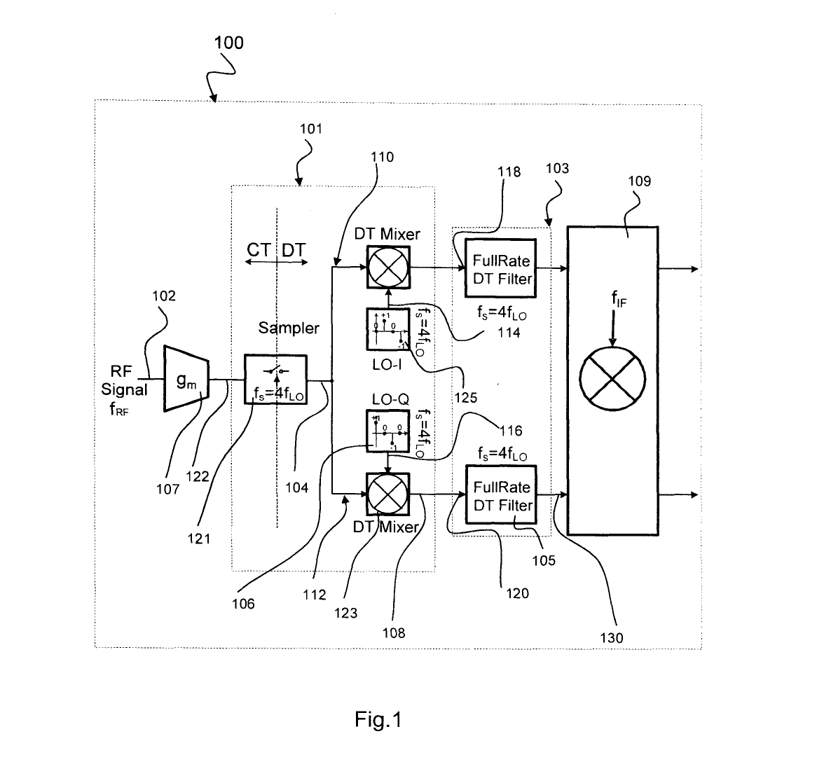

FIG. 1 shows a block diagram of a superheterodyne receiver 100 according to an operational form. The superheterodyne receiver 100 is configured for receiving an analog radio frequency signal 102. The superheterodyne receiver 100 comprises a sampling mixer 101, a discrete-time filter 103, a discrete-time mixer 109 and an analog amplifier 107.

The sampling mixer 101 is configured to sample the analog radio frequency signal 102 of frequency f_{RF} using a certain sampling rate (fₛ) to obtain a discrete-time sampled signal 104, and to shift the discrete-time sampled signal 104 towards a first intermediate frequency |f_{RF}−f_{LO}| (f_{LO} is the local oscillator frequency generated by 106) to obtain an intermediate discrete-time signal 108 sampled at the certain sampling rate fₛ.

The discrete-time filter 103 is configured for discrete-time processing the intermediate discrete-time signal 108 at the certain sampling rate fₛ to obtain a filtered signal 130. The discrete-time mixer 109 is configured to shift the filtered signal 130 towards a second intermediate frequency (f_{IF2}) typically being a baseband or dc frequency.

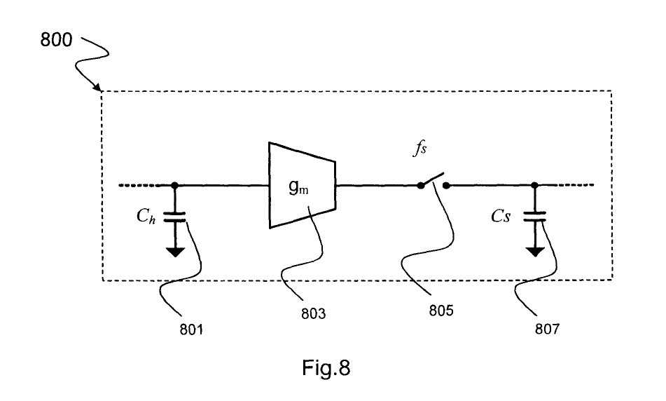

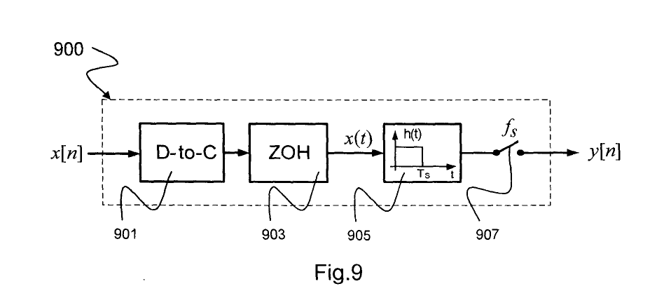

The analog amplifier 107 is configured to receive and amplify the analog radio frequency signal 102 providing an amplified analog radio frequency signal 122. The sampling mixer 101 is coupled to the analog amplifier 107 and is configured to receive the amplified analog radio frequency signal 122 from the analog amplifier 107. In an operational form, the analog amplifier 107 comprises a gₘ stage (i.e., transconductance amplifier) as described below with respect to FIGS. 8 and 9.

The sampling mixer 101 is a quadrature mixer comprising an in-phase path 110 and a quadrature-phase path 112. The sampling mixer 101 comprises a sampler 121 and a quadrature discrete-time (DT) mixer 123. The sampler 121 is configured to sample the amplified analog radio frequency signal 122 providing the discrete-time sampled signal 104. An in-phase part of the quadrature discrete-time mixer 123 is configured to mix the discrete-time sampled signal 104 with an in-phase oscillator signal 114 generated by a local oscillator 125. A quadrature part of the quadrature discrete-time mixer 123 is configured to mix the discrete-time sampled signal 104 with a quadrature-phase oscillator signal 116 generated by the local oscillator 125. In an operational form, the sampling mixer 101 is a direct-sampling mixer. In an operational form, the sampling mixer 101 is configured to oversample the analog radio frequency signal 102 with an oversampling rate and to provide a number of discrete-time sampled sub-signals collectively representing the intermediate discrete-time sampled signal 108.

In an operational form, the sampler 121 is a current sampler for sampling integrated current or charge. The sampler 121 can be represented by a continuous-time (CT) sinc filter with a first notch at 1/Ti with sampling time Ti and anti-aliasing for foldover frequencies. The sampling frequency may correspond to the input-output rate. In DT signal processing input charge (qᵢₙ[n]) is considered as the input sampled signal and output voltage (Vₒᵤₜ[n]) is considered as the output sampled signal according to the following equations:

$${q}_{in} [ n ] = {\int }_{{nT}_{s}}^{{nT}_{s} + {T}_{i}} {i}_{in} ( t ) d t$$

$${V}_{out} [ n ] = \frac{{q}_{in} [ n ]}{{C}_{s}} .$$

In an operational form, the certain sampling rate fₛ is an oversampling rate with an oversampling factor that is 4, i.e., the certain sampling rate fₛ corresponds to four times the frequency of the local oscillator fₛ=4 f_{LO}.

In an operational form, the in-phase path 110 is configured to generate an in-phase oscillator signal 114 with the repeating function [1 0 −1 0]. In an operational form, the quadrature-phase path 112 is configured to generate a quadrature-phase oscillator signal 116 with the repeating function [0 1 0−1]. In an operational form, the in-phase path 110 is configured to generate an in-phase oscillator signal 114 with the repeating function [1 1+√2 1+√2 1 −1 −1−√2 −1−√2 −1]. In an operational form, the quadrature-phase path 112 is configured to generate a quadrature-phase oscillator signal 116 with the repeating function [−1−√2 −1 1 1+√2 1+√2 1 −1 −1−√2].

In an operational form, the discrete-time filter 103 comprises an in-phase path 118 coupled to the in-phase path 110 of the sampling mixer 101 and a quadrature path 120 coupled to the quadrature-phase path 112 of the sampling mixer 101.

In an operational form, the discrete-time filter 103 is configured to filter the intermediate discrete-time signal 108 at the certain sampling rate fₛ. In an operational form, the discrete-time filter 103 is a low-pass filter or band-pass filter, in particular a complex band-pass filter. In an operational form, the discrete-time filter 103 could be configured to perform a charge sharing between an in-phase and a quadrature component (not shown) of the intermediate discrete-time signal 108. In an operational form, the discrete-time filter 103 comprises a switched capacitor circuit.

In an operational form, the sampling mixer 101 can be considered as a quad DT mixer operating at quadruple (4×) rate. The quadruple (4×) sampling concept is for keeping the original sample rate in the subsequent stage, thereby avoiding early decimation. In an operational form further IIR filter are added before decimation.

In an operational form, the superheterodyne receiver 100 is integrated on a single chip without using external filters.

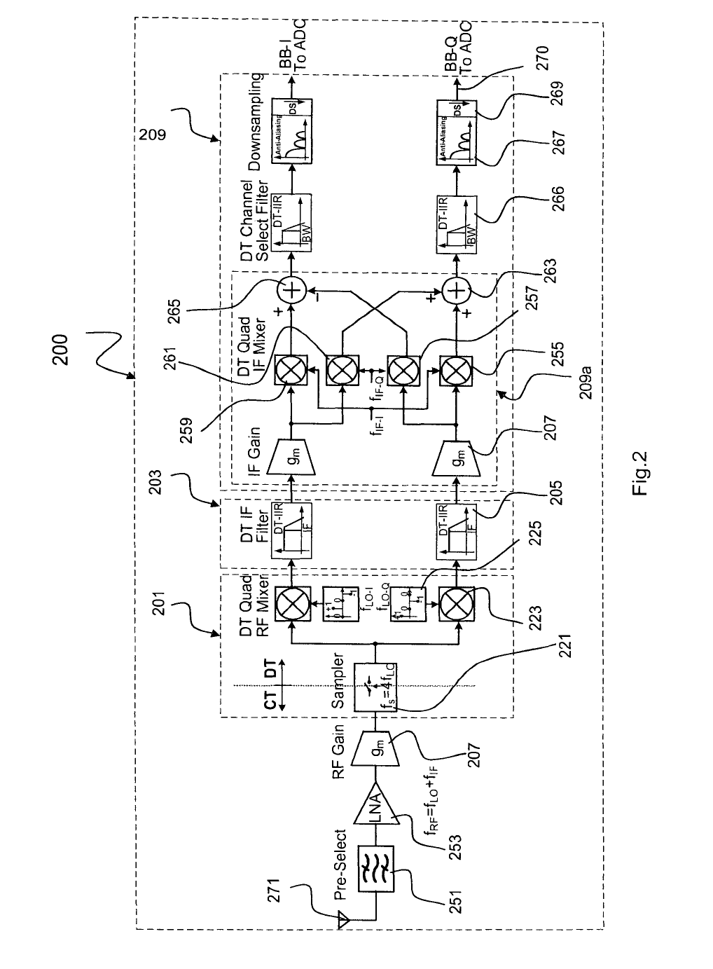

FIG. 2 shows a block diagram of a superheterodyne receiver 200 according to an operational form. The superheterodyne receiver 200 is configured for receiving an analog radio frequency signal received from an antenna 271. The superheterodyne receiver 200 comprises a sampling mixer 201 which may correspond to the sampling mixer 101 described with respect to FIG. 1, a discrete-time filter 203 which may correspond to the discrete-time filter 103 described with respect to FIG. 1 and a discrete-time mixer and filter 209, whose front-end portion may correspond to the discrete-time mixer 109 described with respect to FIG. 1. The superheterodyne receiver 200 comprises a pre-select gain stage 251, a low-noise amplifier (LNA) 253 and an RF gain stage 207, which may correspond to the analog amplifier 107 as described with respect to FIG. 1.

The analog radio frequency signal received from antenna 271 passes the pre-select gain stage 251, the low-noise amplifier (LNA) 253, the RF gain stage 207, the sampling mixer 201, the discrete-time filter 203 and the discrete-time mixer and filter 209 before it is provided to an analog-to-digital converter.

The sampling mixer 201 is configured to sample the output signal received from the RF gain stage 207 using a certain sampling rate fₛ in a sampler 221 to obtain a discrete-time sampled signal, and to shift the discrete-time sampled signal towards a first intermediate frequency f_{IF}=IF_{RF}−f_{LO}| in a DT quadrature RF mixer 223 to obtain an intermediate discrete-time signal sampled at the certain sampling rate fₛ. The quadrature mixer 223 comprises an in-phase path providing an in-phase component and a quadrature path providing a quadrature component of the processed intermediate discrete-time signal.

The discrete-time filter 203 comprises a DT IF filter 205 configured for discrete-time processing the intermediate discrete-time signal at the certain sampling rate fₛ to obtain a filtered signal having in-phase and quadrature component. The discrete-time mixer 209a (comprising of the blocks 207, 259, 261, 257, 255, 265 and 263) is configured to shift the filtered signal towards a second intermediate frequency f_{IF}.

The discrete-time mixer and filter 209 comprises an IF gain stage 207 and a DT quad IF mixer comprising a first mixer component 255, a second mixer component 257, a third mixer component 259, fourth mixer component 261, a first adder 263 and a second adder 265. The discrete-time mixer and filter 209 further comprises a DT channel select filter 266, an anti-aliasing filter 267 and a down-sampler 269. In the DT quad IF mixer, the in-phase path at an input of the DT quad IF mixer is coupled via the fourth mixer component 261 to the first adder 263 and coupled via the third mixer component 259 to the second adder 265; the quadrature path at an input of the DT quad IF mixer is coupled via the first mixer component 255 to the first adder 263 and coupled via the second mixer component 257 to the second adder 265. An output of the first adder 263 forms the quadrature path at an output of the DT quad IF mixer and an output of the second adder 265 forms the in-phase path at an output of the DT quad IF mixer. The in-phase and quadrature paths at the output of the DT quad IF mixer are coupled to the DT channel select filter 266, the anti-aliasing filter 267 and the down-sampler (DS) 269.

The RF input signal is sampled at RF stage and all subsequent operations are done in discrete-time (DT) domain. Hence, the block diagram is divided into two portions: continuous-time (CT) and discrete-time (DT). At first LNA 253 amplifies the received RF voltage signal and RF gain stage 207 converts it into current signal. This amplification reduces input referred noise of the subsequent stages and hence improving the total noise figure (NF) of the receiver. Then, the RF signal is oversampled (i.e., roughly corresponding to the traditional direct sampling) in the sampler 221 with about two times higher than Nyquist rate. This ensures that the RF signal remains at the same frequency after sampling with no down-conversion or frequency translation taking place. In addition, the sampling image frequency is very far away from the wanted RF signal. Also, keeping this high sampling rate in succeeding filtering stages at IF leads to a more powerful filtering. The exact value of sampling rate (fₛ) is chosen in a way to have a straightforward DT LO signal for the DT quadrature RF mixer 223, i.e. [1 0−1 0].

The superheterodyne receiver 200 solves the problem that superheterodyne architectures generally suffer from the IF image frequency by applying quadrature structure. This would be prohibitive in a conventional superheterodyne receiver. Because it needs two separate paths for complex (I and Q) signaling, so it doubles all hardware including costly off-chip IF filter and their buffers. However, in a fully-integrated structure of the superheterodyne receiver 200 as depicted in FIG. 2 this is not an issue.

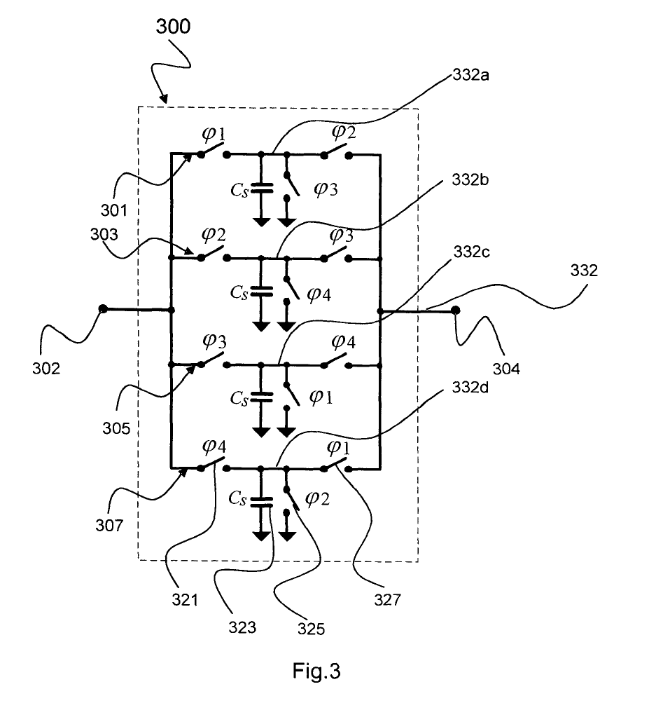

DT quadrature RF mixer 223, 225 down-converts the sampled signal to IF using quadrature DT LO signals and keeps the output sampling rate the same as the sampling rate of the input. In an operational form, IF in this architecture is filtered by the DT IF filter 205 using LPF, BPF or a complex BPF configuration. This DT IF filter 205 operates at least at the same original sample rate of the input without introducing extra image frequencies. In an operational form using a LPF, its corner frequency is slightly higher than IF frequency, e.g. f_{IF}+BW/2. In an operational form using BPF, its center frequency is located at f_{IF}. Also, in the operational form using a complex BPF, its center frequency is placed either at +f_{IF} or −f_{IF} depending on quadrature mixer operation. In the operational form as described below with respect to FIG. 3, a full-rate LPF is used. In an operational form, several cascaded IF filter are used in this architecture to improve its filtering function. Also, the IF gain can be distributed between these IF filters. The high IF frequency can be easily selected to be higher than the flicker noise corner frequency to avoid NF degradation.

The DT quadrature IF mixer 255, 257, 259, 261, 263, 265 down-converts the IF signal to base-band (BB) with negative or positive image frequency rejection. In an operational form having only one local oscillator (LO) for the whole receiver, f_{IF} is an integer division of f_{LO} if the final output is centered at dc.

A chain of DT channel select filters 266, anti-aliasing filters 267, down-sampler 269 and gain stages prepare the signal for ADC. DT channel select filters 266 select one or some adjacent channels and filter out the rest. The high sampling rate after IF mixer is gradually reduced by some down-sampler 269, each protected by an anti-aliasing filter 267. Gain stages provide enough gain so that signal level dynamic range matches ADC's dynamic range.

In an operational form, LNA 253 is implemented as a unified Low-Noise Transconductance Amplifier (LNTA) or a common LNA followed by a RF stage 207.

Sample rate at RF can be calculated from RF and IF frequencies:

$$\{ \begin{matrix}{f}_{RF} = {f}_{LO} \pm {f}_{IF} \\ {f}_{IF} = {f}_{LO} / N\end{matrix} ⇒ {f}_{LO} = \frac{N}{N \pm 1} {f}_{RF} .$$

The simplest DT quadrature LO signal is LO_{I}=[1 0 −1 0] and LO_{Q}=[0 1 0 −1]. Hence input sampling rate is chosen here to be:

fₛ=4×f_{LO}.

In an operational form, sampler 221 and DT quadrature RF mixer 223, 225 are implemented at the same time in one sampling mixer 201 using simple switches as described below with respect to FIG. 3. By providing quadrature LO signals for two Gilbert cells, for example, in order to perform window integration sampling, the RF input signal is sampled and down-converted to IF frequency. At the output of this stage, the samples are stored on sampling capacitors.

In an operational form using filters as described below with respect to FIG. 3, a full-rate LPF is used as the IF filter. The proper order of IF filter can be set based on different requirements of the desired standard.

In an operational form, DT IF mixer 255, 257, 259, 261, 263, 265 in this structure is implemented by some simple switches or by 3^{rd} order image rejection mixer or by even more advanced structures. In an operational form, simple switches are used. In an operational form, quadrature IF LO signals of the IF mixer are IF₁=[1 0 −1 0] and IF_{Q}=[0 1 0 −1]. However, its sample rate is reduced by N. The integration of N samples at IF into the sampling capacitor after IF mixer forms a temporal uniform-weighted N-tap FIR filter, which attenuates alias frequencies more before folding down on the wanted signal. Alias frequencies have been attenuated prior to it by the IF filter.

Right after the IF mixer 255, 257, 259, 261, 263, 265, a DT channel select filter 266 limits bandwidth (BW) to the desired channels. In BB signal processing, decimation can be done in temporal, e.g. by integrating some samples by changing the clock rate or spatial, e.g. by adding different samples on different samplers together. In the superheterodyne receiver 200 depicted in FIG. 2, a temporal decimation is used in the BB.

The superheterodyne receiver 200 uses sufficient filtering so that linearity requirement of the subsequent blocks is relaxed. Thus, in an operational form, the rest of gain is provided by low-power simple gₘ stage instead of by using high linearity opamp and feedback structure.

In an operational form, the superheterodyne receiver 200 is a DT super-heterodyne receiver with some digital backend. In this operational form, the RF Gain is mainly for converting voltage to current. The sampler can be part of DT mixer or subsequent filter. The DT Quad RF Mixer is used for down-converting signal to IF frequency in DT domain. The DT IF Filter is used for suppressing image frequencies of IF mixer. By using IF, gain flicker-free amplification of the signal is provided. The DT Quad IF mixer is for down-converting the signal to baseband. The DT channel select filter is used as narrow-band IIR filter to select desired channel. The down-sampling is performed by decimation with anti-aliasing filter to meet ADC sampling rate.

In the following, considerations are shown for choosing the appropriate IF frequency:
Higher IF (e.g. f_{LO}/8)
   Image frequencies are far from the wanted channel
      the first dominant at f_{RF}±4f_{IF} distance
      Preselect filter and tuned LNA improves image rejection significantly
   Image rejection of the receiver itself would be worse: −50 dB at f_{RF}±2f_{IF}
   Faster switches and gₘ with higher BW is required at IF stage
Lower IF (e.g. f_{LO}/16)
   Better image rejection but more close to the RF signal: −60 dB at f_{RF}±2f_{IF}
   Flicker noise corner should be considered at this lower IF
Dynamic IF
   In busy environment with high level blockers, IF frequency can be switched such that it improves image rejection for that specific blocker signal
      e.g. f_{RF}=1.0625 gigahertz (GHz), f_{LO}=1.0 GHz, f_{IF}=f_{LO}/16=62.5 megahertz (MHz)→f_{img}=812.5 MHz
      f_{RF}=1.0625 GHz, f_{LO}=944.4 MHz, f_{IG}=f_{LO}/8=118 MHz→f_{img}=590.3 MHz

In an operational form, the superheterodyne receiver 200 implements a method with the following steps:
Converting RF signal to current (1^{st} gₘ stage)
Down-conversion of RF signal to IF frequency (RF mixer)
Filtering out important image frequencies of the 2^{nd} mixer (IF filter)
2^{nd} gₘ: more gain and conversion into current
Down-conversion to baseband
Baseband channel selection filtering
Alias-protected decimation for reducing sample rate

Therefore, the superheterodyne receiver 200 has the following advantages:
Getting rid of significant LO feed-through
   LO frequency is different than the received RF signal
Flicker-free gain
No external IF filter
Fully discrete-time operation
   Precise control of filters corner frequencies by capacitor ratio and clock frequency
Scalability: Scaling with Moore's Law

FIG. 3 shows a block diagram of a discrete-time filter 300 of a superheterodyne receiver according to an operational form. In an operational form, the discrete-time filter 300 is used as the discrete-time filter 105 (i.e. a fullrate DT filter) in the in-phase path 110 or in the quadrature-phase path 112 as described with respect to FIG. 1. In an operational form, the discrete-time filters 300 are as described with respect to FIG. 2. The discrete-time filter 300 could be also augmented by a parallel connected sampling capacitor (not shown) at its input or output, or both.

The discrete-time filter 300 comprises a switched capacitor network, and the switched capacitor network comprises an input 302 and an output 304, a number of parallel switched capacitor paths (301, 303, 305 and 307) arranged between the input 302 and the output 304, each switched capacitor path comprising a switched capacitor 323, and a switch circuitry for switching each switched capacitor 323 of the number of parallel switched capacitors at a different time instant for outputting a filtered input signal 332.

The switch circuitry 300 comprises a number of input switches 321 for switching each switched capacitor 323 to the input 302 for charging the switched capacitors 323, the switch circuitry further comprises a number of output switches 327 for switching each switched capacitor 323 to the output 304 for sequentially outputting a number of filtered sub-signals (332a, 332b, 332c and 332d) collectively representing the filtered input signal 332, and the switch circuitry further comprises a number of discharge switches 325, each discharge switch being arranged to switch one switched capacitor 323 to a reference potential for discharging.

The discrete-time filter 300 comprises a first filter path 301, a second filter path 303, a third filter path 305 and a fourth filter path 307, which are coupled in parallel (in the structural sense) between an input 302 and an output 304 of the discrete-time filter 300. Each of these four filter paths 301, 303, 305 and 307 comprises a first switch 321 serially coupled into the filter path, an input of the first switch 321 coupled to an input of the discrete-time filter 300, a capacitor 323, Cs, shunting an output of the first switch 321 to ground, a second switch 325 coupled with its input to an output of the first switch 321 and with its output to ground and a third switch 327 coupled between an input of the second switch 325 and an output of the discrete-time filter 300.

The sampling rate at the input 302 can be described as fₛ₋ᵢₙ=1/Tₛ with sampling time (Tₛ) and the sampling rate at each of the sub-paths 301, 303, 305 and 307 can be described as f_{s-sub}=(1/Tₛ)/4, i.e. a decimation by 4 can be used. However, the output 304 is a time-staggered combination of the sub-path outputs; hence, the full rate is restored.

The discrete time filter 300 depicted in FIG. 3 represents only one out of two components of the discrete-time filters 103 described with respect to FIGS. 1 and 203 described with respect to FIG. 2. The first one of these components is used for filtering the in-phase path while the second one is used for filtering the quadrature path.

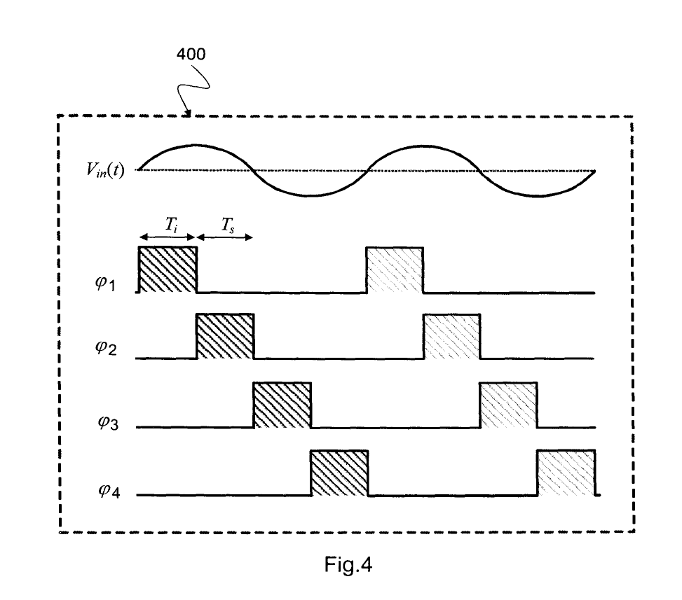

FIG. 4 shows a graph 400 with a set of switching signals for controlling the switches of a discrete-time filter according to an operational form. A first switching signal (φ1) is a pulsed signal with pulse time (Ti) and the composite sample time (Ts). A second switching signal (φ2) is a pulsed signal with Ti and the composite Ts. A third switching signal (φ3) is a pulsed signal with Ti and the composite Ts. A fourth switching signal (φ4) is a pulsed signal with Ti and the composite Ts. In this implementation, the composite Ts corresponds to the Ti. The pulses of the four switching signals are time shifted with respect to each other's Ti. When the φ1 falls from high signal level to low signal level, i.e. the pulse is ending, φ2 rises from low signal level to high signal level, i.e. the pulse is starting. The same condition holds for the relation between the second φ2 and the third φ3 pulse signal, the third φ3 and the fourth φ4 pulse signal and the fourth φ4 and the first φ1 pulse signal.

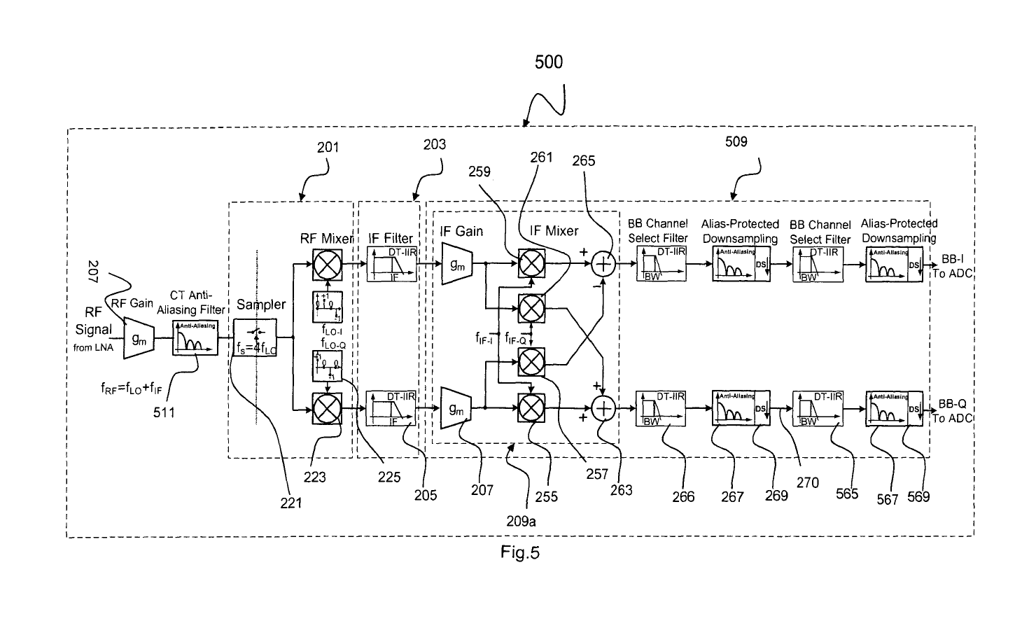

FIG. 5 shows a block diagram of a superheterodyne receiver 500 according to an operational form. The structure of the superheterodyne receiver 500 corresponds to the structure of the superheterodyne receiver 200 described with respect to FIG. 2 but the superheterodyne receiver 500 comprises an anti-aliasing filter 511 coupled between the RF gain stage 207 and the sampler 221. The discrete-time mixer 509 corresponds to the discrete-time mixer and filter 209 described with respect to FIG. 2 but comprises in the downstream direction an additional filtering stage comprising a BB channel selection filter 565, an alias-protection filter 567 and a down-sampler 569.

The additional filtering stage is configured to adapt to the requirements of different ADC specifications, for example Global System for Mobile Communications (GSM), e.g. with 14-bit, 100 kilohertz (kHz) noise shaped AE-ADC sampling at 9-Mega Samples per second (MS/s) or with 14-bit, 500 kHz oversampled ADC (1 bit quantizer), 450-MS/s; long-term evolution (LTE), e.g. with 11-bit, 40 MS/s Nyquist ADC and wideband code division multiple access (WCDMA), e.g. with 9-bit, 8 MS/s Nyquist ADC.

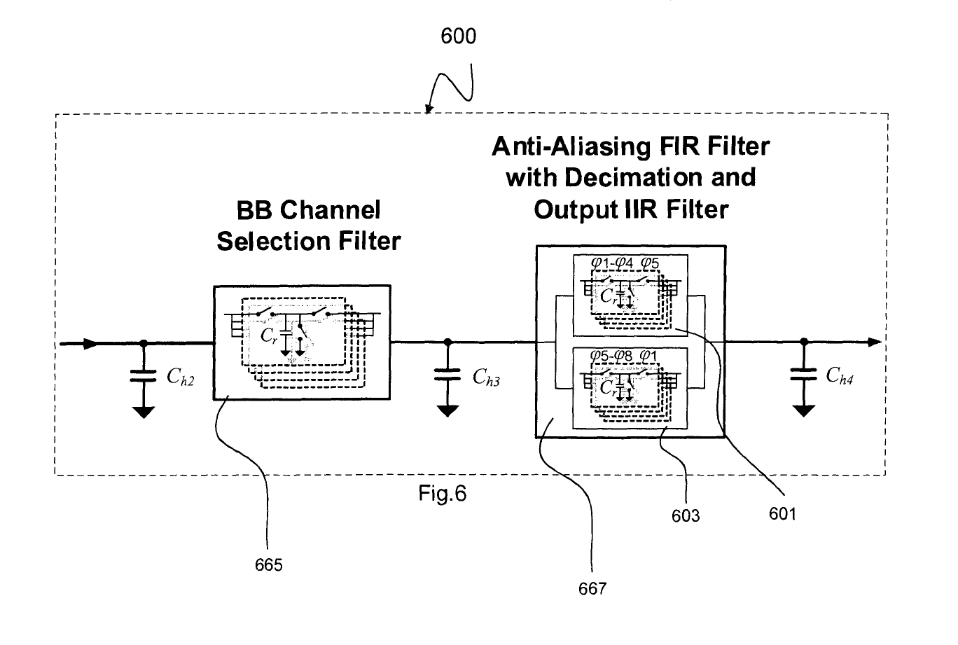

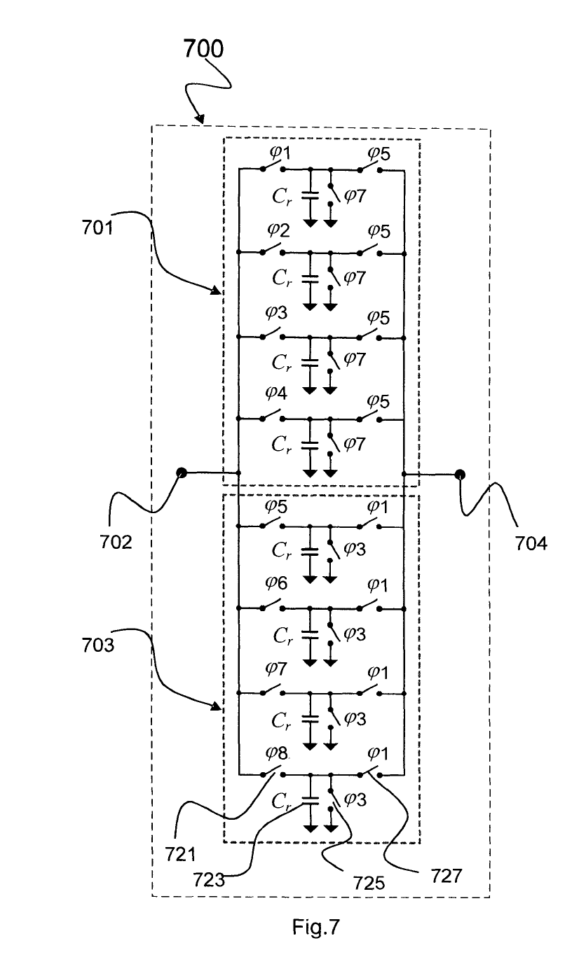

FIG. 6 shows a block diagram of a baseband filtering stage 600 of a superheterodyne receiver according to an operational form. The baseband filtering stage 600 comprises a BB channel selection filter 665 and an anti-aliasing FIR filter 667 with decimation and output IIR filter. Inputs and outputs of both filters 665 and 667 are coupled via shunting capacitors Cₕ₂, Cₕ₃, Cₕ₄ to ground. In an operational form, the structure of the BB channel selection filter 665 corresponds to the filter structure described with respect to FIG. 3. In an operational form, the structure of the BB channel selection filter 665 corresponds to the filter structure described with respect to FIG. 3. In an operational form, the structure of the anti-aliasing FIR filter 667 with decimation and output IIR filter corresponds to the filter structure as described below with respect to FIG. 7. In the operational form depicted in FIG. 6, the anti-aliasing FIR filter 667 with decimation and output IIR filter has a bi-quad structure with two quad paths comprising quad filter structures 601, 603.

The post baseband filtering stage 600 illustrates an implementation for the DT channel selection filter 266 described with respect to FIG. 2 and an implementation for the anti-aliasing filter 267 and the down-sampler 269 as described with respect to FIG. 2.

FIG. 7 shows a block diagram of an anti-aliasing filter 700 of a superheterodyne receiver according to an operational form. The anti-aliasing filter 700 has a bi-quad structure comprising a first quad filter 701 and a second quad filter 703 implemented in parallel between an input 702 and an output 704 of the anti-aliasing filter 700.

The first quad filter 701 comprises four parallel (in a structural sense) filter paths, which are coupled in parallel between the input 702 and the output 704 of the anti-aliasing filter 700. Each of these four filter paths comprises a first switch 721 serially coupled into the filter path, an input of the first switch 721 coupled to an input of the anti-aliasing filter 700, a capacitor 723, Cs shunting an output of the first switch 721 to ground, a second switch 725 coupled with its input to an output of the first switch 721 and with its output to ground (i.e., performing charge reset) and a third switch 727 coupled between an input of the second switch 725 and the output 704 of the anti-aliasing filter 700.

The structure of the second quad filter 703 corresponds to the structure of the first quad filter 701.

FIG. 8 shows a block diagram of an analog amplifier 800 of a radio frequency receiver in continuous-time representation according to an operational form. The analog amplifier 800 comprises an optional first capacitor 801 (this could be represented by a capacitance of the driving stage), a gₘ stage 803, a sampler 805 and a second capacitor 807. The first capacitor 801 is coupled to an input of the analog amplifier 800 and shunts the input to ground. The gₘ stage 803 is coupled with its input to the input of the analog amplifier 800 and with its output to the sampler 805. The sampler 805 is coupled with its output to an output of the analog amplifier 800. The output of the analog amplifier 800 is shunted by the second capacitor 807 to ground. Note that this structure could be used in baseband stages, in which case the input is a voltage on a sampling capacitor Cₕ that belongs to the previous discrete-time stage.

FIG. 9 shows a block diagram of an analog amplifier 900 of a radio frequency receiver in discrete-time representation according to an operational form. An input signal x[n] passes a discrete-time-to-continuous-time (D-to-C) converter 901, a zero-order hold (ZOH) unit 903, a filter 905 and a sampler 907 and is transformed by those functional units to an output signal y[n]. The transformation can be expressed by the following equations:

$$x ( t ) = x [ n ] for n {T}_{s} \leq t < ( n + 1 ) {T}_{s}$$

$$h ( t ) = {g}_{m} / {C}_{s} for 0 \leq t < {T}_{s}$$

$$y [ n ] = {\int }_{{nT}_{s}}^{( n + 1 ) {T}_{s}} x ( t ) d t = \frac{{g}_{m} {T}_{s}}{{C}_{s}} x [ n ] .$$

Thus, the analog amplifier 900 corresponds to a gₘ stage representing a discrete-time (DT) gain.

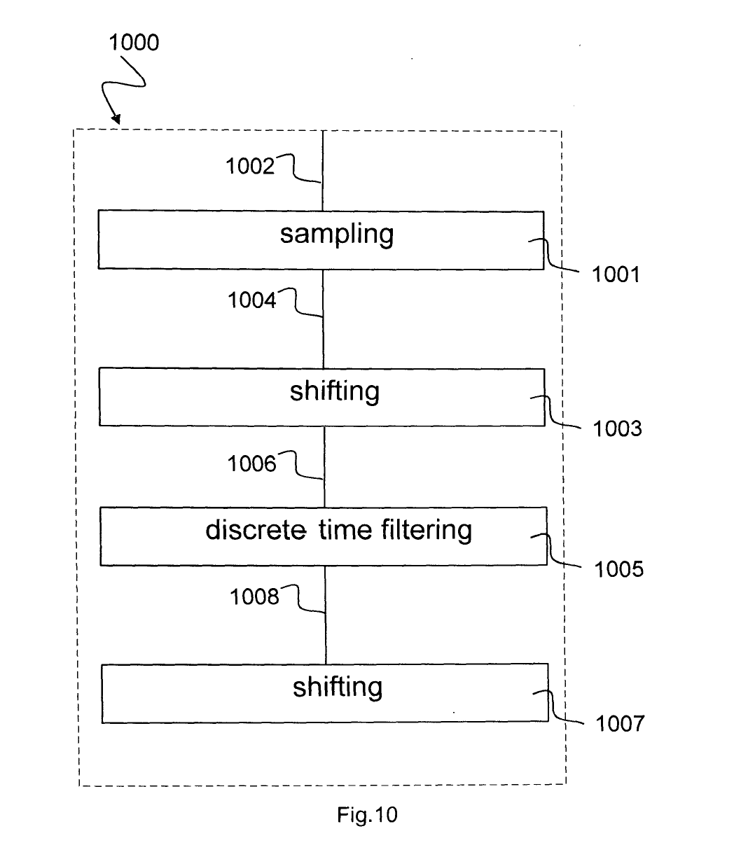

FIG. 10 shows a schematic diagram of a superheterodyne receiving method 1000. The superheterodyne receiving method 1000 comprises: sampling 1001 of an analog radio frequency signal 1002 using a certain sampling rate to obtain a discrete-time sampled signal 1004; frequency shifting 1003 of the discrete-time sampled signal 1004 towards a first intermediate frequency to obtain an intermediate discrete-time signal 1006 sampled at the certain sampling rate; discrete-time filtering 1005 of the intermediate discrete-time signal 1006 at the certain sampling rate to obtain a filtered signal 1008; and shifting 1007 the filtered signal 1008 towards a second intermediate frequency, which could be baseband frequency.

What is claimed is:

1. A superheterodyne receiver, comprising:
a sampling mixer configured to:
sample an analog radio frequency signal using a certain sampling rate (fₛ) to obtain a discrete-time sampled signal; and
shift the discrete-time sampled signal towards a first intermediate frequency (|f_{RF}−f_{LO}|) to obtain an intermediate discrete-time signal sampled at the fₛ;
a discrete-time filter configured to filter the intermediate discrete-time signal at the fₛ to obtain a filtered signal; and
a discrete-time mixer configured to shift the filtered signal towards a second intermediate frequency (f_{IF}).

2. The superheterodyne receiver of claim 1, wherein the f_{IF} is a baseband frequency.

3. The superheterodyne receiver of claim 1, wherein the discrete-time mixer is configured to operate at a decimated sampling rate that is lower than the fₛ.

4. The superheterodyne receiver of claim 1, wherein the discrete-time mixer is an image-reject mixer.

5. The superheterodyne receiver of claim 1, wherein the discrete-time filter is a low-pass filter.

6. The superheterodyne receiver of claim 1, wherein the discrete-time filter is a band-pass filter.

7. The superheterodyne receiver of claim 1, wherein the discrete-time filter is a complex band-pass filter.

8. The superheterodyne receiver of claim 1, wherein the discrete-time filter is configured to perform a charge sharing between an in-phase and a quadrature-phase component of the intermediate discrete-time signal.

9. The superheterodyne receiver of claim 1, wherein the fₛ is an oversampling rate with an oversampling factor that is at least 2.

10. The superheterodyne receiver of claim 1, wherein the fₛ is an oversampling rate with an oversampling factor that is at least 4.

11. The superheterodyne receiver of claim 1, wherein the discrete-time filter comprises a switched capacitor network comprising:
an input;
an output;
a plurality of parallel switched capacitor paths arranged between the input and the output, wherein each switched capacitor path comprises a switched capacitor; and
a switch circuitry configured to switch each switched capacitor at a different time instant, thereby outputting a filtered input signal.

12. The superheterodyne receiver of claim 11, wherein the switch circuitry is configured to switch each switched capacitor beginning with a different phase of a common clock signal.

13. The superheterodyne receiver of claim 11, wherein the switch circuitry comprises:
a plurality of input switches configured to switch each switched capacitor to the input, thereby charging the switched capacitors;
a plurality of output switches configured to switch each switched capacitor to the output, thereby sequentially outputting a plurality of filtered sub-signals collectively representing the filtered input signal; and
a plurality of discharge switches, wherein each discharge switch is arranged to switch one of the switched capacitors to a reference potential, thereby discharging the switched capacitor.

14. The superheterodyne receiver of claim 1, wherein the sampling mixer is a quadrature mixer comprising an in-phase path and a quadrature-phase path, wherein the in-phase path is configured to generate an in-phase oscillator signal with the repeating function [1 0 −1 0], and wherein the quadrature-phase path is configured to generate a quadrature-phase oscillator signal with the repeating function [0 1 0 −1].

15. The superheterodyne receiver of claim 1, wherein the sampling mixer is a quadrature mixer comprising an in-phase path and a quadrature-phase path, wherein the in-phase path is configured to generate an in-phase oscillator signal with the repeating function [1 1+√2 1+°2 1 −1 −1√2 −1−√2 −1], and wherein the quadrature-phase path is configured to generate a quadrature-phase oscillator signal with the repeating function [−1−√2 −1 1 1+√2 1+°2 1 −1 −1−√2].

16. The superheterodyne receiver of claim 1, wherein the discrete-time mixer comprises a down-sampler configured to provide the filtered signal shifted towards the f_{IF} with a sampling rate reduced towards the fₛ.

17. The superheterodyne receiver of claim 1, further comprising a converting amplifier configured to convert a voltage signal into a current signal, wherein the converting amplifier is connected to the output of the discrete-time filter.

18. The superheterodyne receiver of claim 1, further comprising a transconductance (gₘ) stage converting amplifier configured to convert a voltage signal into a current signal, wherein the gₘ stage converting amplifier is connected to the output of the discrete-time filter.

19. The superheterodyne receiver of claim 1, wherein the discrete-time mixer is a quadrature mixer, and wherein the sampling mixer is a quadrature sampling mixer.

20. A superheterodyne receiving method, comprising:
sampling an analog radio frequency signal using a certain sampling rate to obtain a discrete-time sampled signal;
shifting the discrete-time sampled signal towards a first intermediate frequency to obtain an intermediate discrete-time signal sampled at the certain sampling rate;
discrete-time filtering the intermediate discrete-time signal at the certain sampling rate to obtain a filtered signal; and
shifting the filtered signal towards a second intermediate frequency.

21. An apparatus comprising:
at least one processor configured to:
sample an analog radio frequency signal using a certain sampling rate to obtain a discrete-time sampled signal;
shift the discrete-time sampled signal towards a first intermediate frequency to obtain an intermediate discrete-time signal sampled at the certain sampling rate;
discrete-time filter the intermediate discrete-time signal at the certain sampling rate to obtain a filtered signal; and
shift the filtered signal towards a second intermediate frequency.
